(19) United States
(12) Patent Application Publication
(10) Pub. No.: US 2011/0237114 A1
(43) Pub. Date: Sep. 29, 2011

(54) Cord hook device

(76) Inventors: Dale Beene, Tallahassee, FL (US); Gerry Goodson, Havana, FL (US)

(21) Appl. No.: 12/661,749

(22) Filed: Mar. 23, 2010

(51) Int. Cl. H01R 13/62

(52) U.S. Cl. 439/373

(57) ABSTRACT

A cord hook device for attaching to an existing outlet in order to secure a cord. The cord hook device is generally comprised of a plate, having a first receptacle opening and a second receptacle opening, a trunk portion extending away from the plate between the first and second receptacle, and two arms extending away from the trunk portion, configured to secure a cord. An aperture passes through the trunk portion and the plate and secures the device to an existing outlet receptacle.

### BACKGROUND OF THE INVENTION

1. Field of the Invention

This invention relates to the field of devices made for outlet covers. More specifically, the invention comprises an electrical outlet cover cord hook device which allows for the hooking of the cord to the outlet cover.

2. Description of the Related Art

Presently, outlet covers are semi-flat plates which fit over an electrical socket. The outlet covers typically screw in place via a central screw surrounding the existing wall socket (electrical outlet).

When an electrical device is being utilized, the male electrical connector of the device is plugged into the electrical outlet. Oftentimes during the time in which the device is being used the electrical connector is inadvertently pulled from the electrical outlet, interrupting power to the device. For example, a vacuum cord can be easily and unintentionally pulled from the wall socket as the vacuum is moved throughout the room.

Therefore what is needed is an electrical outlet cover which prevents a cord from unintentionally disengaging from the electrical outlet. The present invention achieves this objective, as well as others that are explained in the following description.

### BRIEF SUMMARY OF THE INVENTION

The present invention is a cord hook device which allows the user to secure a cord plugged into an electrical outlet in order to prevent the plug from being yanked out of the electrical outlet. The cord hook device is generally comprised of a plate, a trunk portion and two arms. In the preferred embodiment the trunk portion is integrated with the plate. Two arms extend away from the trunk portion at a first end and curve back in towards the plate at a second end. Each arm has two knobs at the arms second end, which prevent cord from slipping out from beneath either arm. An aperture configured to accept a screw passes through the trunk portion and the plate in order to secure the device to an existing outlet receptacle.

### BRIEF DESCRIPTION OF THE SEVERAL VIEWS OF THE DRAWINGS

FIG. 1 is a perspective view, showing the preferred embodiment of the present invention.

FIG. 2 is a rear view, showing the back of the present invention.

FIG. 3 is cross section view, showing a horizontal cross section of the present invention.

FIG. 4 is a perspective view, showing the present invention being connected to an existing electrical outlet.

FIG. 5 is a perspective view, showing the present invention connected to an existing electrical outlet.

FIG. 6 is a perspective view, showing a first portion of a cord being placed under a first arm of the present invention.

FIG. 7 is a perspective view, showing a second portion of a cord being placed under a second arm of the present invention.

FIG. 8 is a perspective view, showing an electrical cord wrapped around the present invention.

FIG. 9 is a perspective view, showing an alternate embodiment of the present invention.

FIG. 10 is a perspective view, showing an alternate embodiment of the present invention.

### REFERENCE NUMERALS IN THE DRAWINGS

| | | | |
|---|---|---|---|
| 10 | cord hook device | 12 | plate |
| 14 | receptacle opening | 16 | trunk portion |
| 18 | arm | 20 | knob |
| 22 | aperture | 24 | outlet receptacle |
| 26 | fastener | 28 | aperture |
| 30 | plug | 32 | cord |
| 34 | aperture | 36 | fastener |
| 38 | aperture | 40 | alternate cord hook device |
| 42 | plate | 44 | receptacle opening |
| 46 | trunk portion | 48 | arm |
| 50 | knob | 52 | segment piece |
| 54 | outlet receptacle | | |

### DETAILED DESCRIPTION OF THE INVENTION

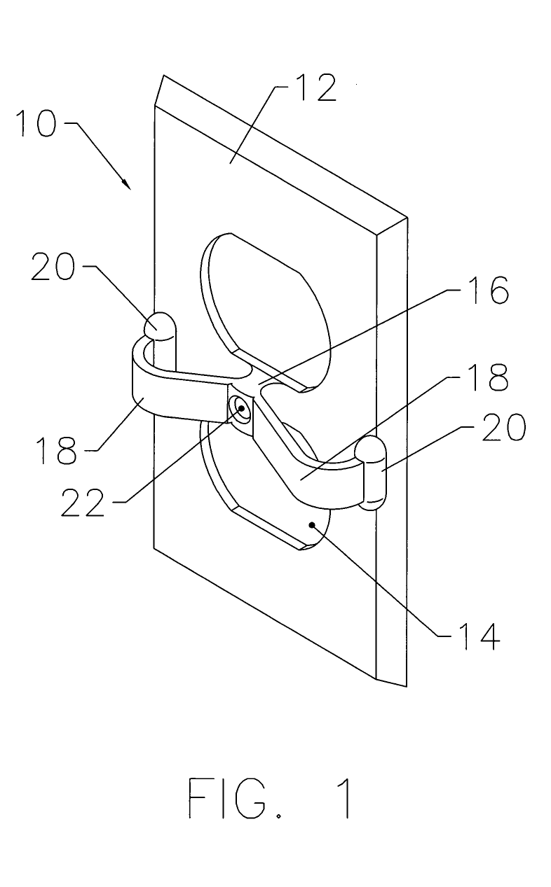

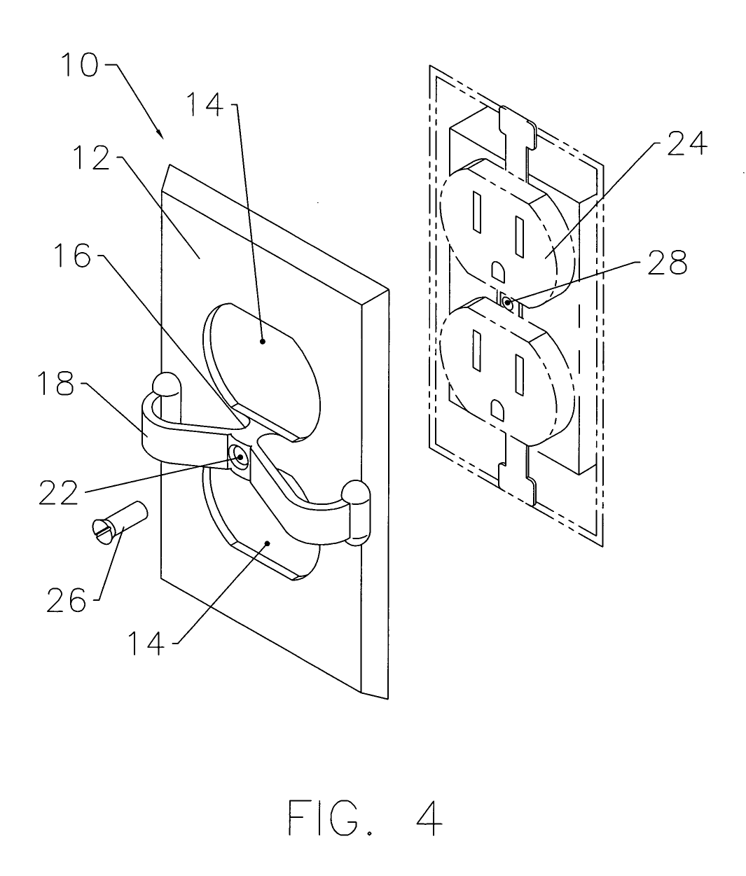

FIG. 1 illustrates the present cord hook device 10 in the preferred embodiment. The cord hook device 10 is preferably an integrated piece generally comprised of plate 12, at least two receptacle openings 14, trunk portion 16 and two arms 18. Trunk portion 16 extends outward from plate 12, preferably at the center of plate 12 between the two receptacle openings 14. Aperture 22 extends through the center of trunk portion 16 and through a portion of plate 12 in order to accept fastener 26 (shown in FIGS. 4 & 5). Arms 18 extend laterally away from trunk portion 16 curving first out away from plate 12 and then back in, having an endpoint which is perpendicular to the plane plate 12 sits in. Knob 20 is attached at the end of each arm 18. In the preferred embodiment, cord hook device 10 is a molded plastic material. However, the present invention can be made up of a variety of different materials. Materials would be known to one with skill in the art to be able to withstand the forces necessary to prevent arms 18 from snapping under the particular force generated.

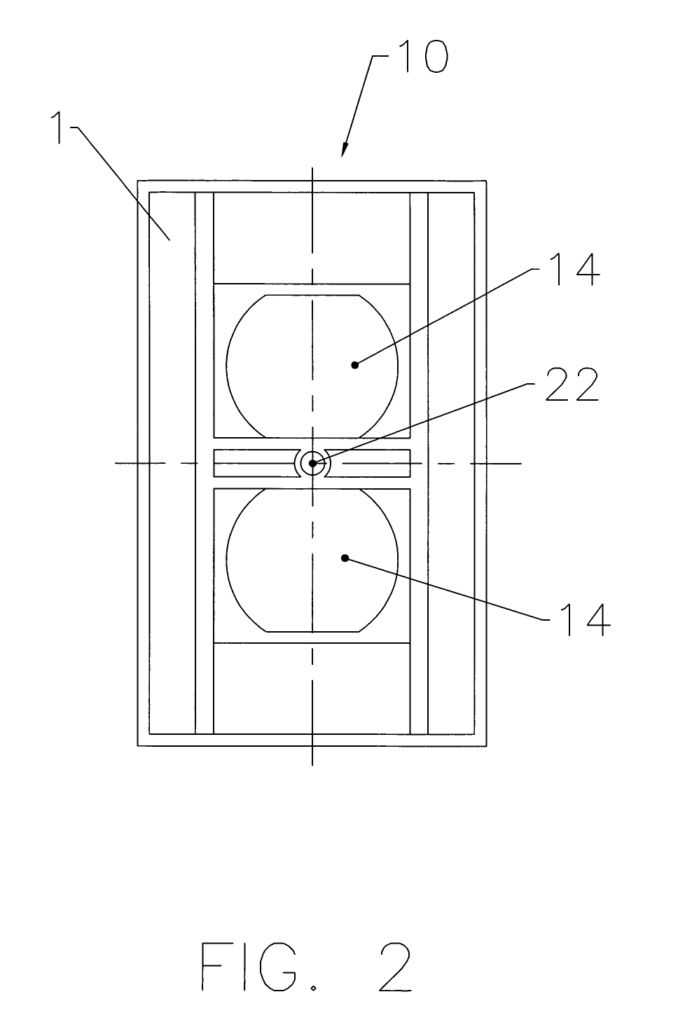

The back of cord hook device 10 is shown in FIG. 2. The back of cord hook device 10 is similar to the back of prior art outlet covers. Two receptacle openings 14 sit above and below aperture 22.

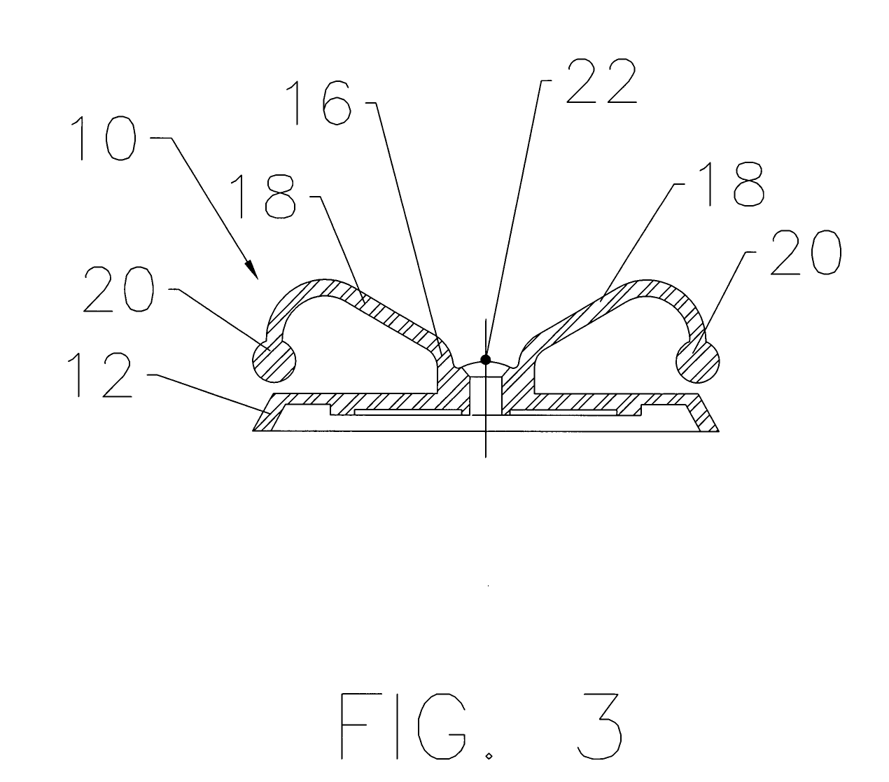

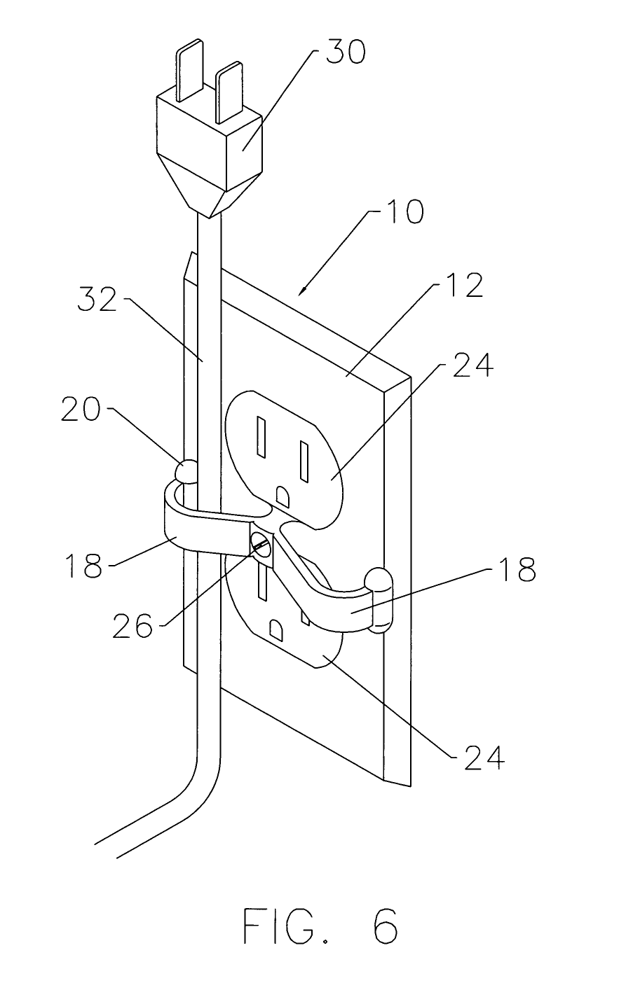

A cross section of cord hook device 10 is illustrated in FIG. 3. Aperture 22 is clearly shown extending through center of trunk portion 16 and center of plate 12. This view also illustrates the preferred geometrical curve of each arm 18. Arms 18 initially extend away from plate 12 and trunk portion 16 but curve back towards plate 12, having an endpoint which is preferably perpendicular to the plane which plate 12 lies in. Each arm 18 ends at knob 20. The width of knob 20 is greater than the width of arm 18. The importance of the curvature of arms 18 and width of knob 20 is described below and further illustrated in FIG. 6.

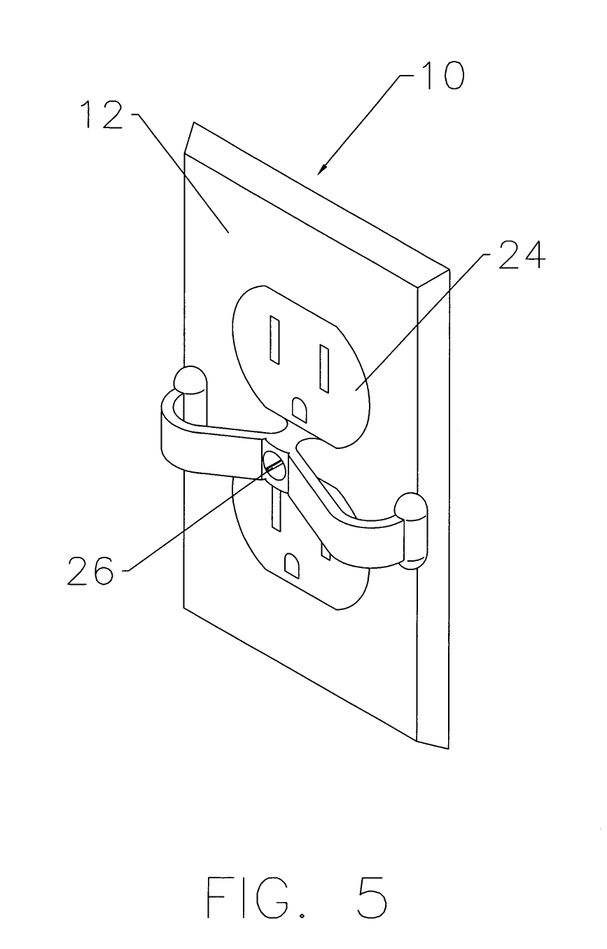

The present cord hook device 10 is adapted to fit over existing outlet having outlet receptacles 24 as shown in FIG. 4. Prior art outlets generally contain aperture 28 for attachment of a prior art outlet cover. As illustrated the present cord hook device 10 is secured to existing outlet by way of fastener 26, preferably a screw, which travels through aperture 22 in trunk portion 16 of present cord hook device 10 and into aperture 28 in existing outlet. Receptacle openings 14 align with and accept outlet receptacles 24. FIG. 5 illustrates present cord hook device 10 fully attached to existing outlet. As shown, outlet receptacle 24 can be fully accessed through cord hook device 10.

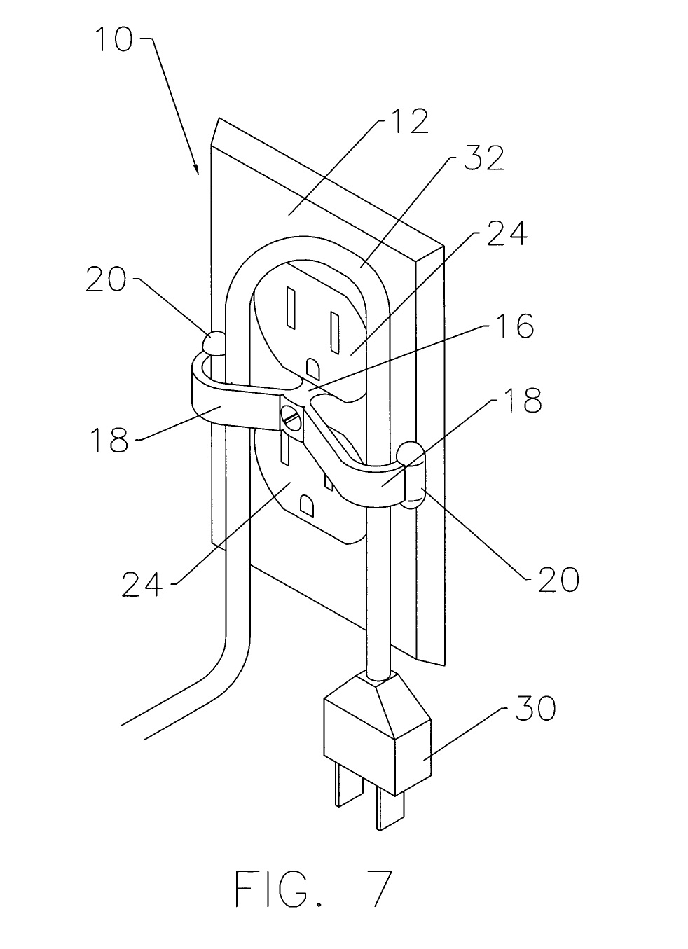

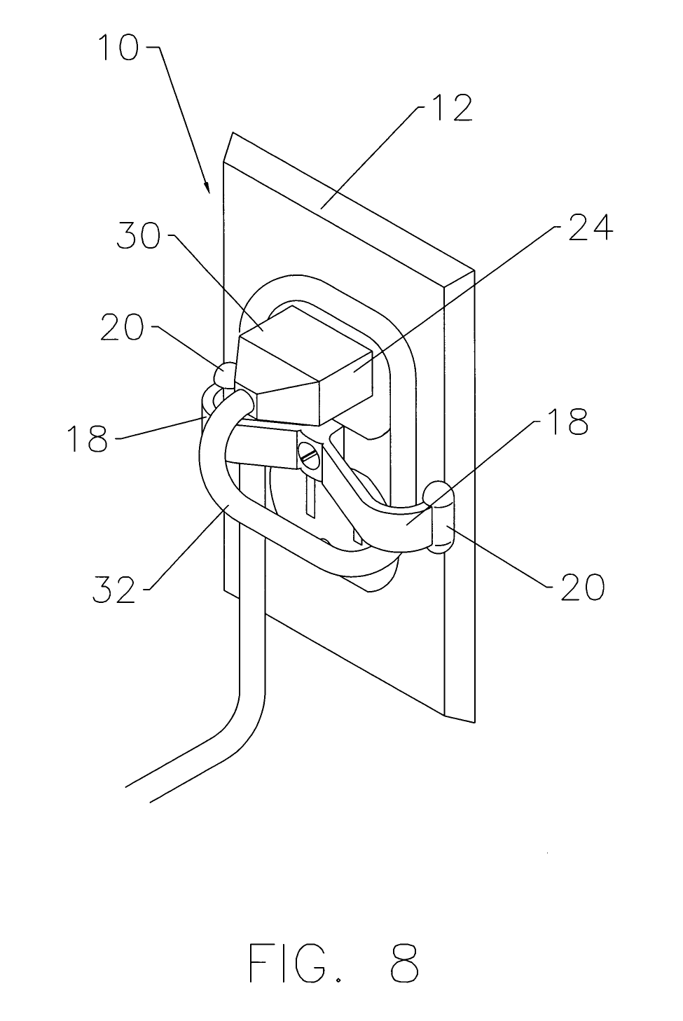

FIG. 6-8 portrays the manner in which an electrical device is plugged in and secured using the present cord hook device 10. FIG. 6 shows a first portion of cord 32 being placed under arm 18 and knob 20. Cord 32 easily slides under knob 20 into the void which arm 18 forms. Cord 32 is brought back under a second arm 18 as shown in FIG. 7 and plugged into outlet receptacle 24 as shown in FIG. 8 and described below. While this particular method of looping cord 32 around cord hook device 10 is illustrated, any method of looping cord 32 around cord hook device 32 could be utilized.

In FIG. 8 plug 30 is plugged into outlet receptacle 24 with cord 32 enveloped by cord hook device 10. The curvature of arms 18 allows cord 32 to be easily positioned in and out of arms 18 while also forming a hook to retain cord 32 securely once cord 32 is wrapped around trunk portion 16. Knobs 20 are wider than the width of arms and therefore prevent cord 32 from slipping outside of arms 18 in the event that cord 32 is pulled laterally away from cord hook device 10. It is in this manner that plug 30 will not inadvertently disengage from outlet receptacle 24, even if a strong force were to pull cord 32 away from outlet receptacle 24.

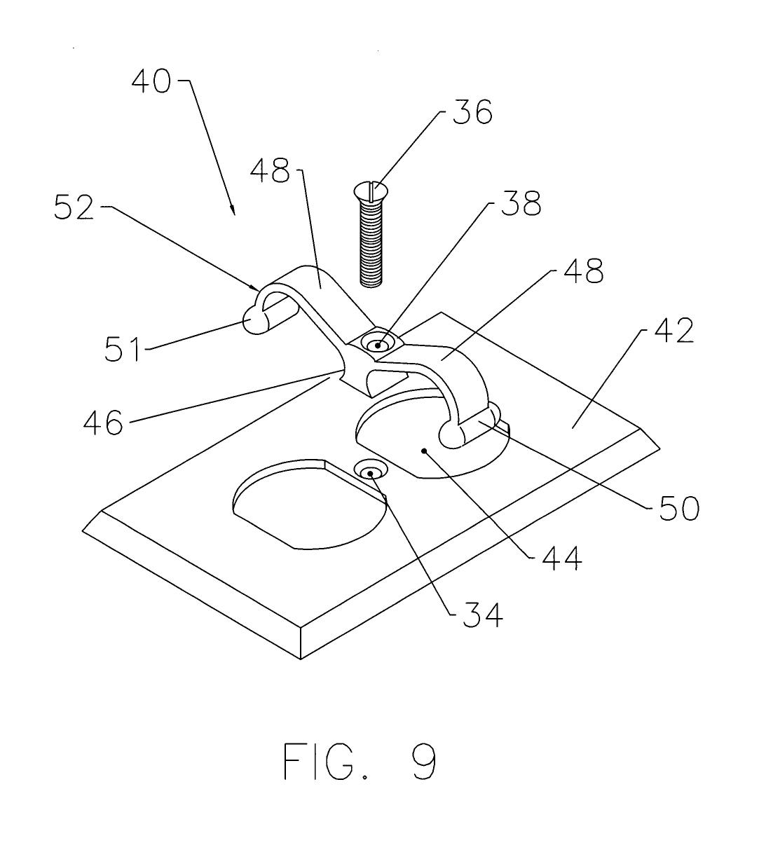

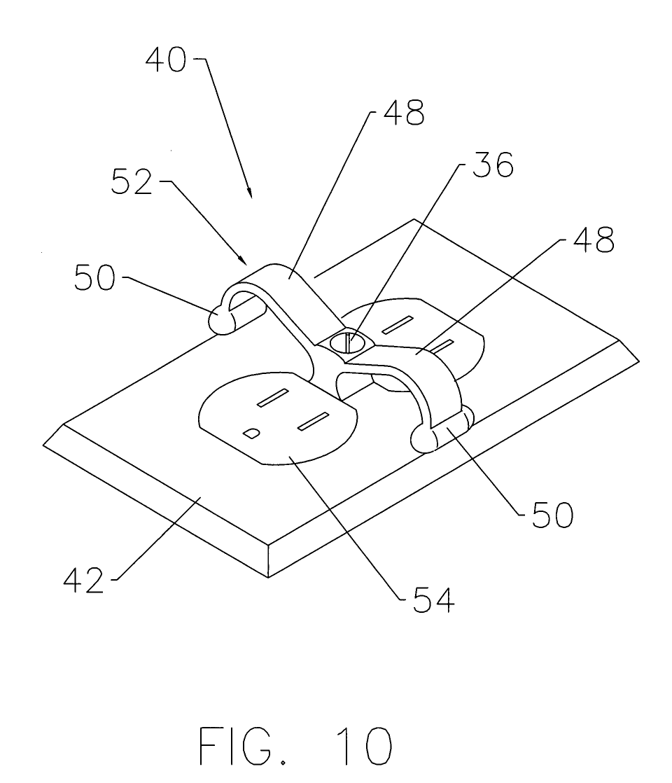

The illustration in FIG. 9 shows an alternate embodiment of the present invention. Alternate cord hook device 40 is shown in position to fit over existing outlet. Plate 42 can be any prior art plate which contains a central aperture 34 for connection to an existing outlet. Alternate cord hook device 40 contains segment piece 52. Segment piece 52 can be sold separately from plate 42 in this alternate embodiment. Segment piece 52 consists of at least two arms 48, trunk portion 46, aperture 38 and at least two knobs 50. Fastener 36 connects segment piece 52 to plate 42 which ultimately connects to existing outlet. FIG. 10 shows segment piece 52 connected to existing outlet by fastener 36. Receptacle openings 44 on plate 42 (shown in FIG. 9) accept receptacles 54. When fully assembled alternate cord hook device 40 appears nearly identical to the preferred embodiment.

The preceding description contains significant detail regarding the novel aspects of the present invention. It should not be construed, however, as limiting the scope of the invention but rather as providing illustrations of the preferred embodiments of the invention. As an example, segment piece 52 could be separate from plate 42. Additionally, plate 12 could contain more than two receptacle openings 14. Thus, the scope of the invention should be fixed by the following claims, rather than by the examples given.

Having described my invention, I claim:

1. A cord hook device for attaching to an existing outlet securing a cord, said device comprising:
a. a plate having at least one receptacle opening;
b. a trunk portion having a first end and a second end;
i. wherein said first end extends out from said plate;
ii. wherein at least two arms are attached to said second end;
c. an aperture through said trunk portion and said plate between said a least two arms;
d. wherein said at least two arms extend away from said trunk portion at a first end; and
e. wherein said at least two arms curve back towards said plate at a second end.

2. A cord hook device as recited in claim 1, wherein said first end of said at least two arms connect to said trunk portion and said second end of said at least two arms connect to at least two knobs.

3. A cord hook device as recited in claim 2, wherein said aperture is configured to accept a screw.

4. A cord hook device as recited in claim 3, wherein said screw connects said cord hook device to an aperture in an outlet receptacle within an existing wall.

5. A cord hook device as recited in claim 1, wherein said cord hook device is made up of plastic.

6. A cord hook device as recited in claim 2, wherein said at least two knobs are configured to prevent said cord when secured from slipping out from behind said at least two arms.

7. A cord hook device for attaching to an existing outlet securing a cord, said device comprising:
a. a plate having a first receptacle opening and a second receptacle opening;
b. a trunk portion extending from said plate between said first receptacle opening and said second receptacle opening;
c. a first arm having a first end and a second end;
i. wherein said first end of said first arm extends away from said trunk portion;
ii. wherein said second end of said first arm curves back towards said plate;
d. a second arm having a first end and a second end;
i. wherein said first end of said second arm extends away from said trunk portion;
ii. wherein said second end of said second end curves back towards said plate;
e. a first knob attached to said second end of said first arm and a second knob attached to said second end of said second arm; and
f. an aperture passing through said trunk portion and said plate between said first arm and said second arm.

8. A cord hook device as recited in claim 7, wherein said aperture is configured to accept a screw.

9. A cord hook device as recited in claim 7, wherein said screw connects said cord hook device to an aperture in an outlet receptacle within an existing wall.

10. A cord hook device as recited in claim 7, wherein said cord hook device is made up of plastic.

11. A cord hook device as recited in claim 8, wherein said first knob is configured to prevent said cord when secured from slipping out from behind said first arm.

12. A cord hook device as recited in claim 11, wherein said second knob is configured to prevent said cord when secured from slipping out from behind said second arm.

13. A cord hook device for attaching to an existing outlet securing a cord, said device comprising:
a. a plate having a first receptacle opening and a second receptacle opening;
b. a trunk portion configured to attach to said plate between said first receptacle opening and said second receptacle opening;
c. a first arm having a first end and a second end;
i. wherein said first end of said first arm extends away from said trunk portion;
ii. wherein said second end of said first arm curves back towards said plate;
d. a second arm having a first end and a second end;
i. wherein said first end of said second arm extends away from said trunk portion;
ii. wherein said second end of said second end curves back towards said plate when said trunk portion is attached to said plate;
e. a first knob attached to said second end of said first arm and a second knob attached to said second end of said second arm; and
f. an aperture passing through said trunk portion between said first arm and said second arm.

14. A cord hook device as recited in claim 13, wherein said aperture of said trunk portion is configured to accept a screw.

15. A cord hook device as recited in claim 14, wherein said plate is configured to accept a screw.

16. A cord hook device as recited in claim 15, wherein said screw connects said trunk portion to said plate.

17. A cord hook device as recited in claim 16, wherein said trunk portion and said plate to an outlet receptacle within an existing wall.

18. A cord hook device as recited in claim 13, wherein said cord hook device is made up of plastic.

19. A cord hook device as recited in claim 13, wherein said first knob is configured to prevent said cord when secured from slipping out from behind said first arm.

20. A cord hook device as recited in claim 19, wherein said second knob is configured to prevent said cord when secured from slipping out from behind said second arm.
